(19) United States
(12) Patent Application Publication
(10) Pub. No.: US 2007/0078793 A1
(43) Pub. Date: Apr. 5, 2007

(54) System and method for aggregating item delivery information

(76) Inventors: Stephen M. Dearing, Cordova, TN (US); Gerald J. Jamula, New Boston, MI (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/524,352

(22) Filed: Sep. 21, 2006

Related U.S. Application Data
(60) Provisional application No. 60/718,725, filed on Sep. 21, 2005.

(51) Int. Cl. G06F 17/00

(52) U.S. Cl. 705/401

(57) ABSTRACT

Systems and methods for aggregating item delivery statistics in an item delivery system. In accordance with an illustrative embodiment, information associated with one or more delivery items is collected at one or more locations in the item delivery system. The collected item delivery information is forwarded to a management system configured to store the information. The management system receives related information for a plurality of delivery items and aggregates at least some of the related information. In response to a user request, the management system may be configured to return a selected set of aggregated item delivery statistics to the user. The user can use the aggregated statistics to identify trends, bottlenecks, service standards, and other flow-related information that could not be easily tracked using prior item delivery systems.

### CROSS-REFERENCE TO RELATED APPLICATION

Under provisions of 35 U.S.C. § 119(e), this application claims the benefit of U.S. Provisional Application No. 60/718,725, filed Sep. 21, 2005 and entitled “CONFIRM MAILER DIAGNOSTIC TOOL,” by Stephen M. Dearing et al., which application is incorporated herein by reference in its entirety.

### TECHNICAL FIELD

The disclosure herein relates to the field of analysis and diagnosis of delivery service effectiveness. More particularly, the disclosure herein relates to methods and systems for providing a delivery service subscriber with the capability to analyze and evaluate mail flow and mail delivery statistics on an aggregate basis.

### BACKGROUND

The UNITED STATES POSTAL SERVICE® (“USPS”), an independent establishment of the United States government, is one example of an item delivery system that provides item delivery services to the public. The USPS® is widely recognized as a safe and reliable means for sending and receiving mail and other delivery items, such as packages, parcels, boxes, bundles, packets, envelopes, and the like.

The USPS currently offers an information service, known as the CONFIRM® service, that allows shippers to confirm delivery of sample mailpieces sent through the POSTAL SERVICE® system. A shipper who subscribes to the CONFIRM service is assigned a subscriber identifier, and the subscriber identifier may be used to generate a PLANET® (Postal Alpha Numeric Encoding Technique) code associated with a sample mailpiece. The combination of the PLANET code and a conventional POSTNET® code uniquely identifies the sample mailpiece as it traverses the POSTAL SERVICE system. Specifically, as the subscriber's sample mailpiece makes each transition along its delivery path (e.g., pickup, transport to a USPS mail processing facility, en route, delivery, and the like), the PLANET and POSTNET codes enable the CONFIRM service to provide the subscriber with near real-time tracking of the mailpiece's location in the POSTAL SERVICE system. In this manner, the CONFIRM service can track each sample mailpiece.

The CONFIRM service generally provides subscribers with various types of tracking information including, but not limited to, information associated with when the sample mailpiece is inducted into the POSTAL SERVICE system, when the mailpiece is sorted, when the mailpiece passes through various mail processing facilities, when the mailpiece is delivered, and so forth. The subscribers' sample mailpieces may include, for example, FIRST-CLASS MAIL™ letters and other material, STANDARD MAIL™ letters and other material, PERIODICALS MAIL™ and other material, as well as automation-compatible letters, periodicals, flats, and other materials that are both sent or received in the POSTAL SERVICE system.

The CONFIRM service is configured to track both destinating and originating mail. In this context, “destinating mail” and “destinating mailpiece” refer to one or more mailpieces that a CONFIRM service subscriber sends into the POSTAL SERVICE system to an addressee. The destinating mailpieces are tracked by their destinating locations in the POSTAL SERVICE system until they are received by the addressee. “Originating mail” and “originating mailpiece” also refer to one or more mailpieces that a CONFIRM service subscriber sends into the POSTAL SERVICE system to an addressee. However, the originating mailpieces are tracked by their Point of Entry (“POE”), or “originating” location, until they are received by the addressee.

While CONFIRM service subscribers can track movement and statistics of individual mailpieces in the POSTAL SERVICE system, the subscribers are presently unable to analyze the “flow” (movement) of a plurality of mailpieces on an aggregate basis (e.g., by ZIP® code, by city, by state, by region, nationwide, and the like). More generally, there is a need for systems and methods that provide a shipping service subscriber with the capability to analyze and evaluate the flow of delivery items and track item delivery statistics on an aggregate basis.

### SUMMARY

Embodiments consistent with the present invention address the disadvantages of the prior art by providing novel systems and methods for aggregating item delivery statistics in an item delivery system. The item delivery system may be a mail delivery system configured to deliver destinating and/or originating mailpieces. In accordance with an illustrative embodiment, information associated with one or more delivery items is collected at one or more locations in the item delivery system. The collected item delivery information is forwarded to a management system configured to store the information. The management system receives related information for a plurality of delivery items and aggregates at least some of the related information. In response to a user request, the management system may be configured to return a selected set of aggregated item delivery statistics to the user. The user can use the aggregated statistics to identify trends, bottlenecks, service standards, and other flow-related information that could not be easily tracked using prior item delivery systems.

Further to the illustrative embodiment, a shipper may send the management system a pre-shipment notification before inducting one or more delivery items into the item delivery system. The pre-shipment notification may be sent to the management system electronically, e.g., as a conventional Electronic Mailing Data (“EMD”) data file. The management system may employ a database, or other data structure, configured to store and aggregate item delivery statistics. Accordingly, the management system may establish a new database entry for the shipper's delivery items based on the contents of the pre-shipment notification. The management system database may include a centralized database, e.g., located in a centralized server, or alternatively may be distributed across multiple servers in the item delivery system.

After sending the pre-shipment notification, the shipper inducts the one or more delivery items into the item delivery system for delivery to an addressee. As the items are being delivered, data associated with the delivery items may be measured or otherwise acquired at various locations in the item delivery system. The item delivery data is then sent to the management system for storage and potential aggregation. For instance, one or more optically readable codes, such as PLANET and/or POSTNET codes, associated with the delivery items may be optically scanned at the various locations. The scanned data can be forwarded to the management system for updating the database entry associated with the delivery items.

The management system is configured to analyze information stored in its database and aggregate at least some of the information to determine a set of aggregated item delivery statistics. The statistics may be made available to requesting users of the item delivery system. The users may include, for example, subscribers of an item delivery service, such as the CONFIRM service, as well as employees and administrators of the item delivery system. Other users may include automated devices, such as mail processing equipment, or software agents configured to communicate with the management system. Preferably, each user selects one or more aggregation criteria for determining which aggregated statistics to retrieve from the management system. Alternatively, the set of aggregated statistics that the management system makes available to the user may be predefined, e.g., by a system administrator or the like.

The management system may report the requested aggregated statistics to the user in a variety of different formats. For example, the user may interface with a graphical user interface (“GUI”) which graphically presents the aggregated statistics to the user. Alternatively, the user may receive a text-based report containing the requested item delivery statistics. The user-requested statistics may be formatted as percentages and/or raw data aggregated by the management system.

It is to be understood that both the foregoing general description and the following detailed description are exemplary and explanatory only, and should not be considered restrictive of the scope of the invention set forth in the appended claims. Further, features and/or variations may be provided in addition to those expressly set forth herein. For example, embodiments of the invention may be directed to various combinations and sub-combinations of the features described in the following detailed description.

### BRIEF DESCRIPTION OF THE DRAWINGS

The accompanying drawings, which are incorporated in and constitute a part of this specification, illustrate embodiments consistent with the invention and together with the description, serve to explain the principles of the invention. In the drawings:

FIG. 1 is a block diagram of an exemplary system environment for providing a shipping service subscriber the capability to analyze and evaluate delivery item flow on an aggregate basis;

FIGS. 2A-H and 2J illustrate various elements of an exemplary file format that may be used to create an electronic pre-shipment notification data file in an item delivery system;

FIG. 3 is an exemplary shipping notice that may accompany one or more delivery items as the items are delivered in an item delivery system;

FIG. 4 is a block diagram of an exemplary computing device that may be used as a subscriber computer, server, and/or mail processing equipment in the exemplary system environment;

FIG. 5 is a flow diagram of an exemplary process for aggregating item delivery statistics consistent with the invention;

FIG. 6 is a flow diagram of an exemplary process for providing a delivery item service subscriber the capability to analyze and evaluate delivery item flow and item delivery statistics on an aggregate basis;

FIGS. 7A-B illustrate exemplary graphical user interfaces (“GUI”) for entering data and selecting reporting options for displaying item delivery statistics and summary reports;

FIG. 8 illustrates an exemplary GUI for graphically displaying a nationwide view of item delivery statistics aggregated by geographic regions; and

FIG. 9 illustrates an exemplary GUI for displaying originating summary reports containing item delivery statistics for delivery items originating in a first area and delivered to one or more destination areas. The exemplary GUI also may include information for accessing and displaying additional mail delivery statistics based on user selection.

### DETAILED DESCRIPTION

Reference will now be made in detail to illustrative embodiments consistent with the invention, examples of which are illustrated in the accompanying drawings. Wherever possible, the same reference numbers will be used throughout the drawings to refer to the same or like parts. Moreover, although exemplary embodiments described herein may be directed to mail delivery, it is to be understood that the present invention is not so limited, but may be practiced on other types of delivery items such as packages, parcels, boxes, packets, envelopes, and the like.

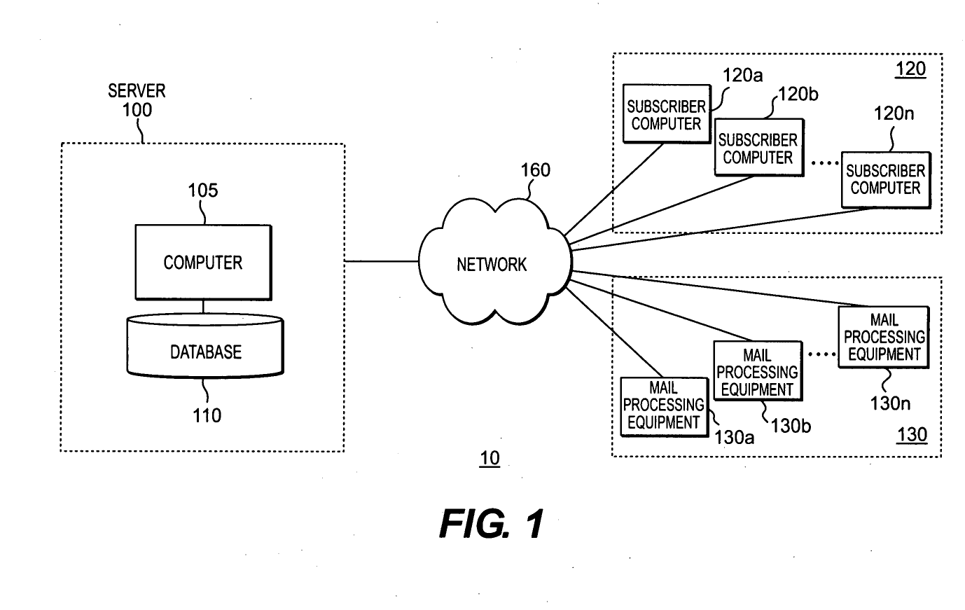

FIG. 1 is a block diagram of an exemplary item delivery system environment 10, consistent with the invention. The components of system 10 may be adapted to provide a mail service subscriber with the capability to analyze and evaluate mail flow on an aggregate basis (e.g., by ZIP® code, by city, by state, by region, nationwide, and the like). The subscriber is a user of the mail service and may also be a shipper of mail in system 10. Data associated with the mail may originate from one or more subscriber computers 120 and one or more mail processing equipment 130. The data associated with the mail may be transmitted via a network 160 from the subscriber computers and mail processing equipment to a management system, such as server 100. Examples of subscriber computers 120a-n include computing devices or platforms (e.g., computers, laptops, servers, mainframes, and the like) that may be used by individuals, companies, organizations, or any entities that provide mail for processing and delivery in the system 10.

Network 160 may be any combination of wired or wireless networks for facilitating the electronic communication of data. By way of example, network 160 may comprise a private network, such as a local-area network, or a wide-area network, and/or a public network, such as the Internet. Further, conventional protocols and encryption methods may be utilized for electronically transmitting data over network 160. For example, HyperText Transfer Protocol (“HTTP”) and File Transfer Protocol (“FTP”) may be used for data transfers, and encryption may be achieved through secure file transfer protocol or secure copy.

The mail processing equipment 130a-n generally refers to equipment at mail processing facilities that process one or more pieces of mail while the mail is en route from a source to a destination. The mail processing equipment may perform one or more predetermined functions when the equipment reads certain codes associated with the mail. For example, the equipment may scan for data associated with the mail, route the mail according to the data associated with the mail, and/or send the data associated with the mail to a computer (e.g., computer 105 in server 100, which may also include a database 110 for storing the data).

One example of mail processing equipment is the Advanced Facer Canceller System (“AFCS”) used by USPS. The AFCS includes software for reading optically-readable codes (e.g., PLANET® code, POSTNET® code, and the like) on individual pieces of mail. When processing a piece of mail, if the AFCS reads a particular optically-readable code, the AFCS may generate an image of the mail and extract data associated with the mail using imaging software (e.g., optical character recognition software). AFCS may include an interface for communicating with network 160 to send data associated with the mail to server 100 for data processing.

Data associated with the mail may include, for example, manually entered information obtained from hard-copy forms, such as PS Form 8125, and information obtained via electronic files, such as Electronic Mailing Data (“EMD”) files submitted by subscribers via the subscriber computers 120a-n, as well as scan data acquired by the mail processing equipment 130a-n. Scan data from the mail processing equipment 130a-n may be acquired by scanning at least one optically readable code (e.g., PLANET code, POSTNET code, and the like) that is associated with the mail and used by a mail service (e.g., USPS's CONFIRM® service) to monitor and track the mail. The scan data may include, for example, shipment identification (“ID”), subscriber ID, a destination code (such as a destination ZIP CODE®), date, time, and/or the name of the mail processing facility.

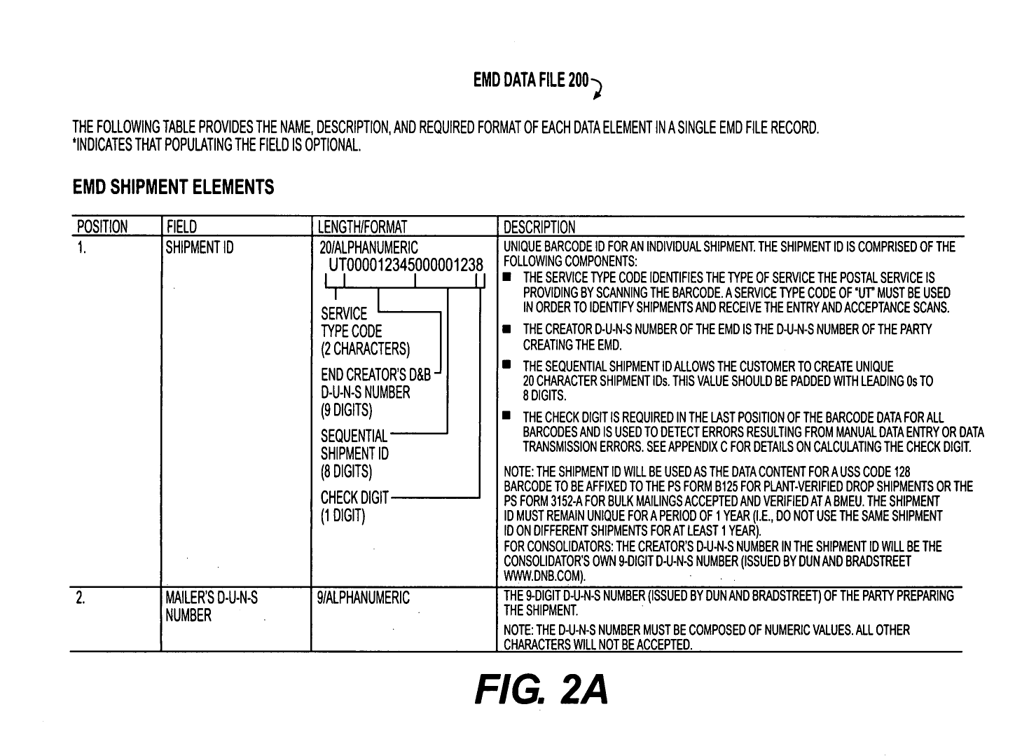

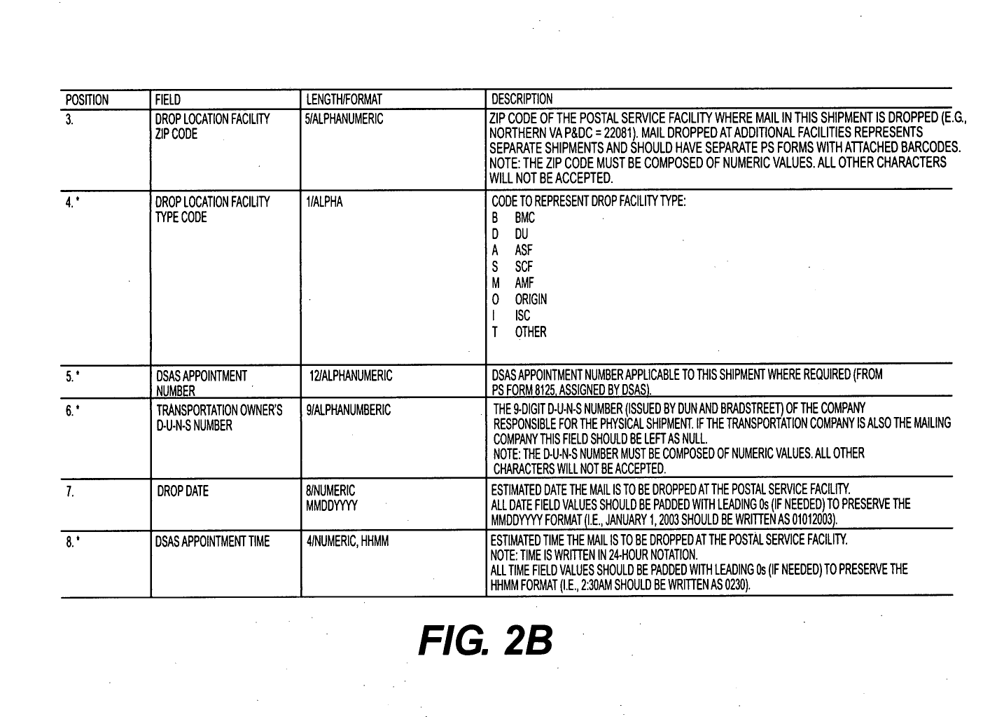

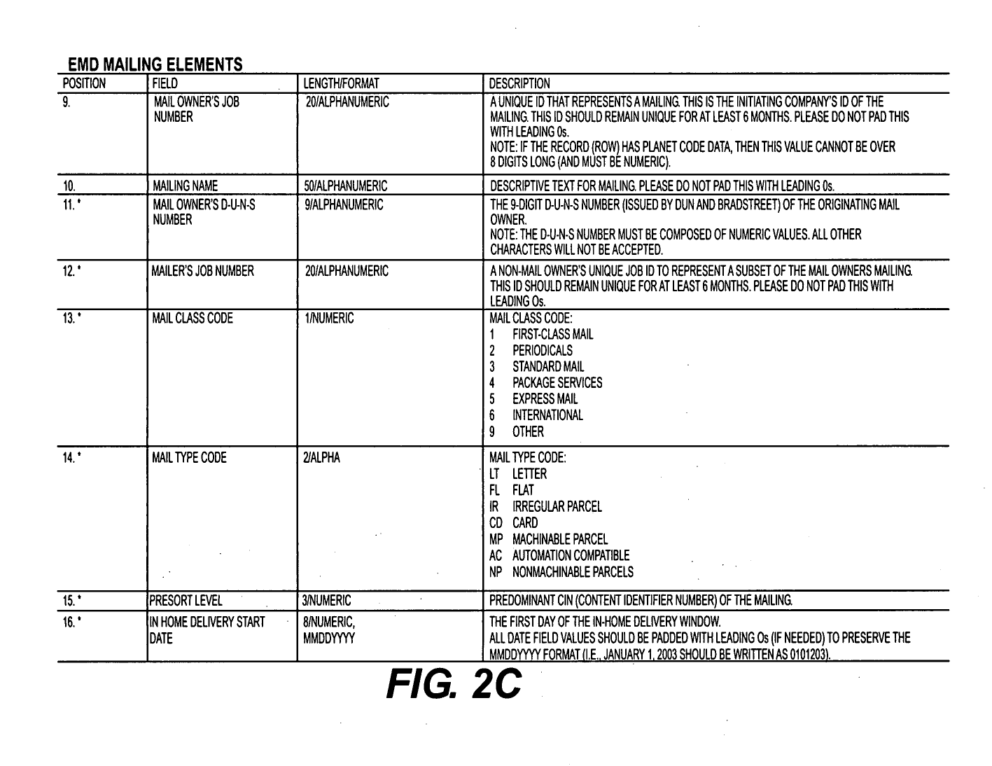

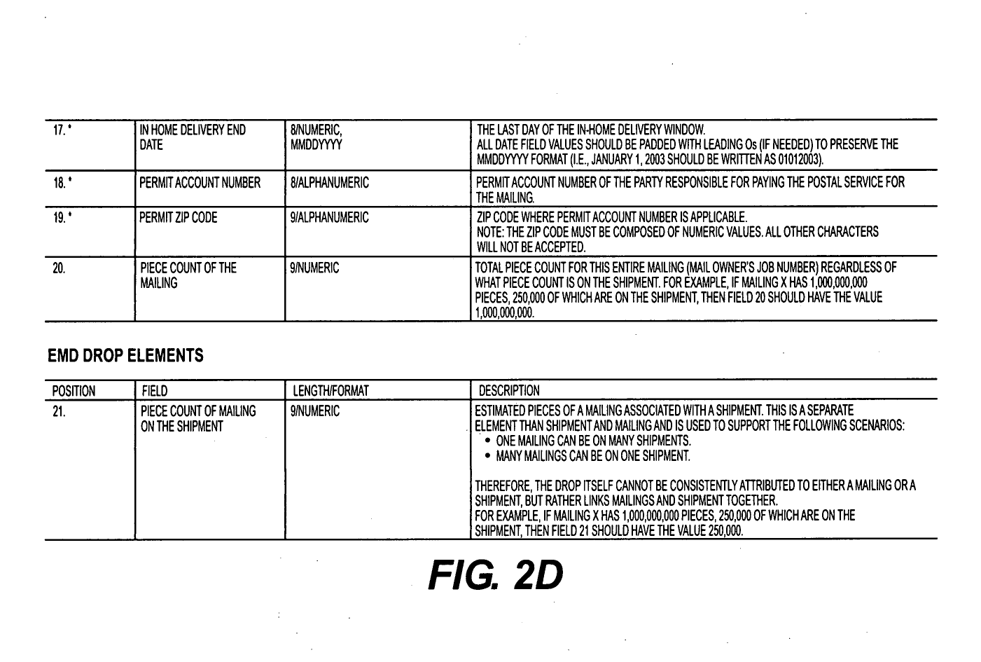

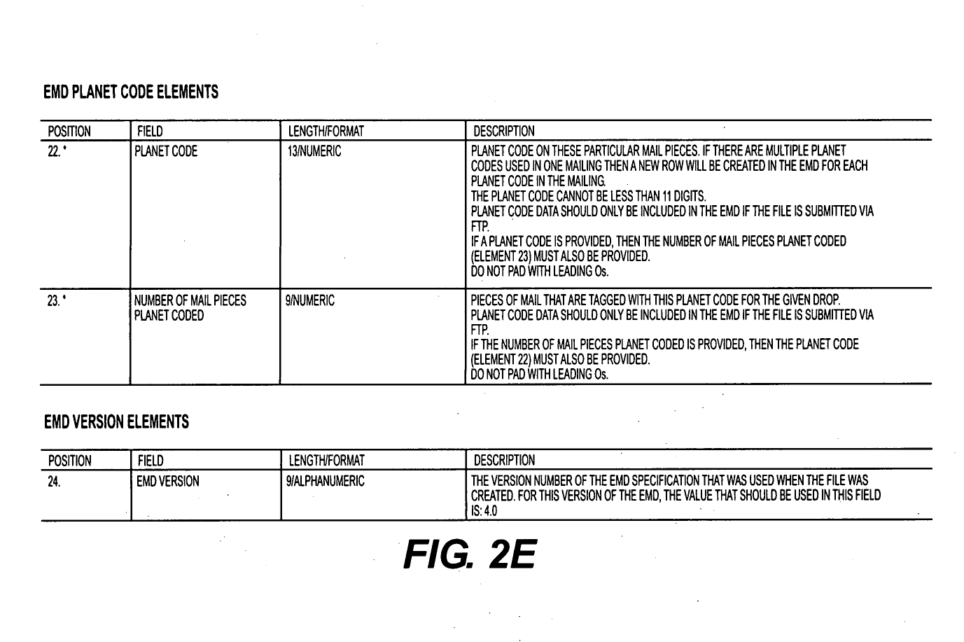

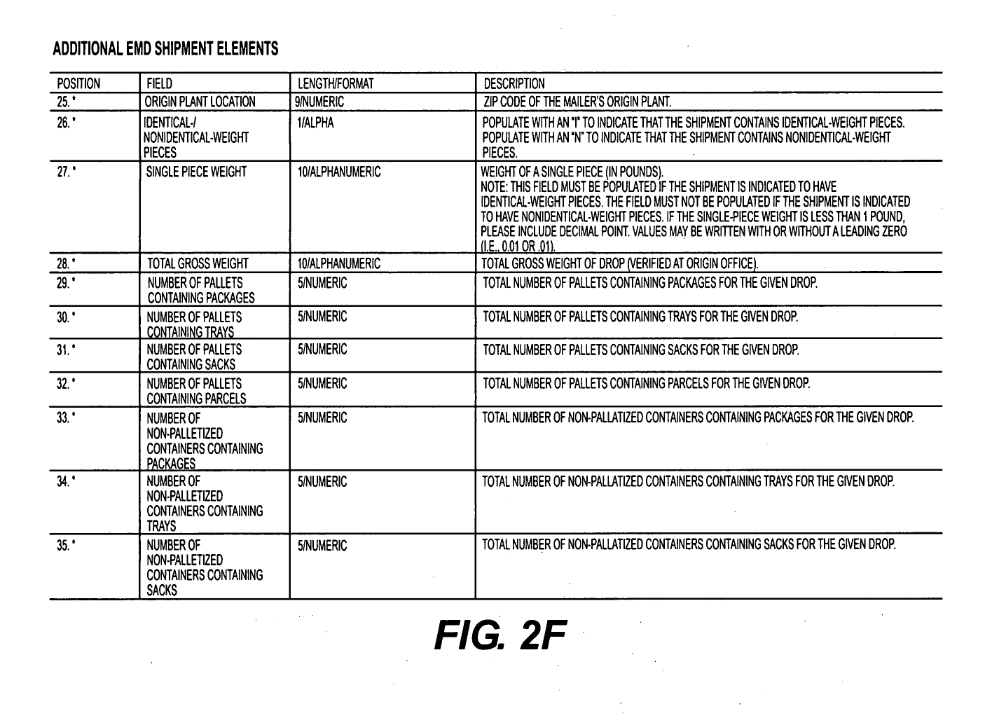

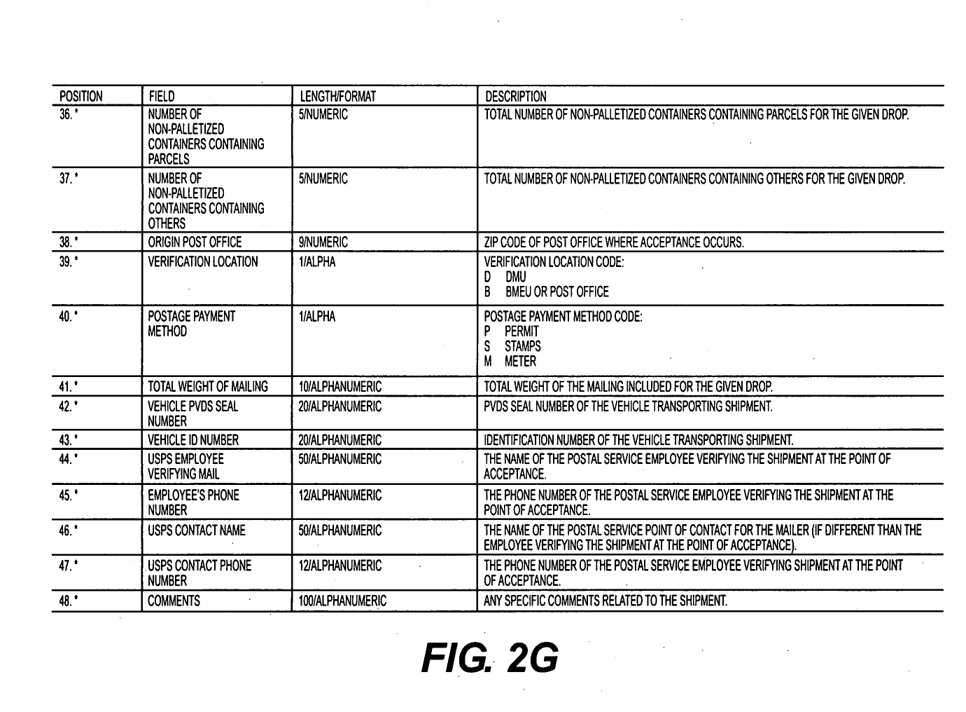

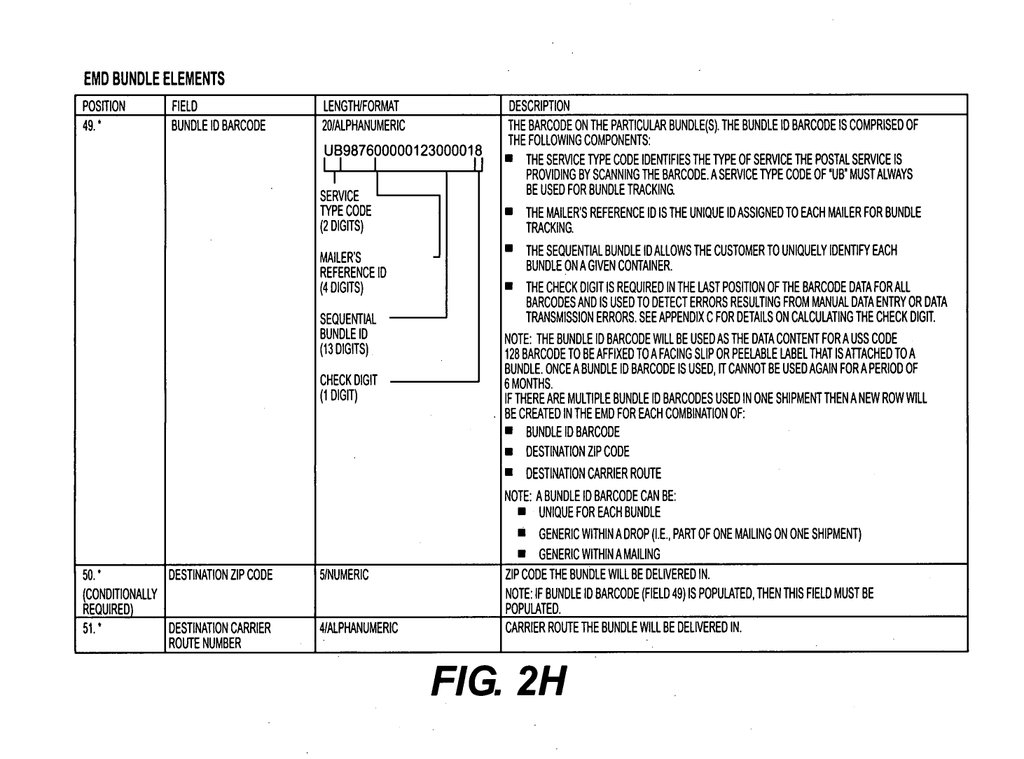

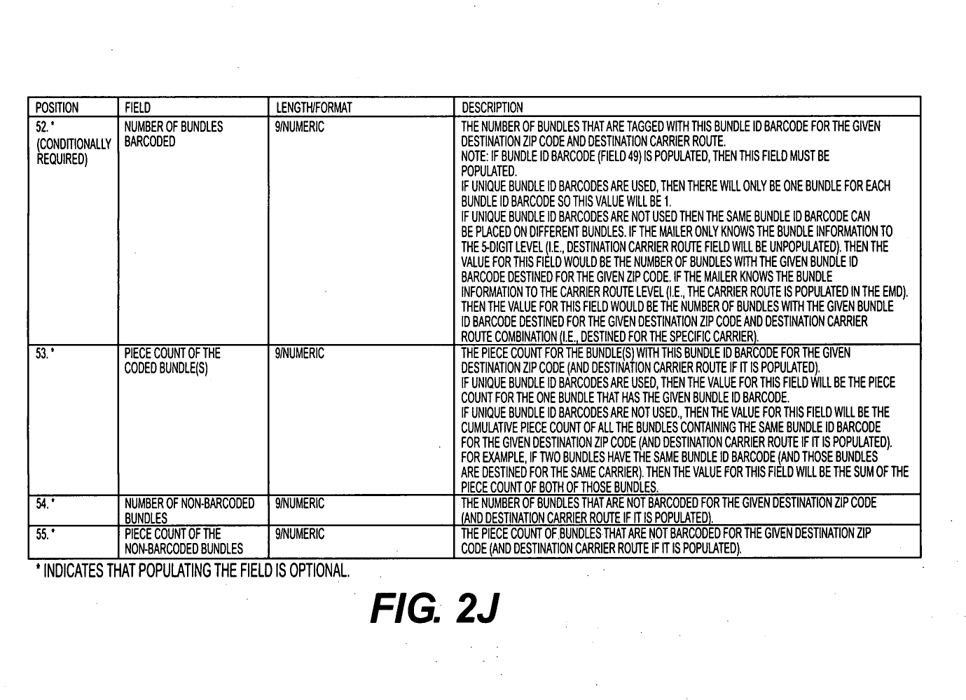

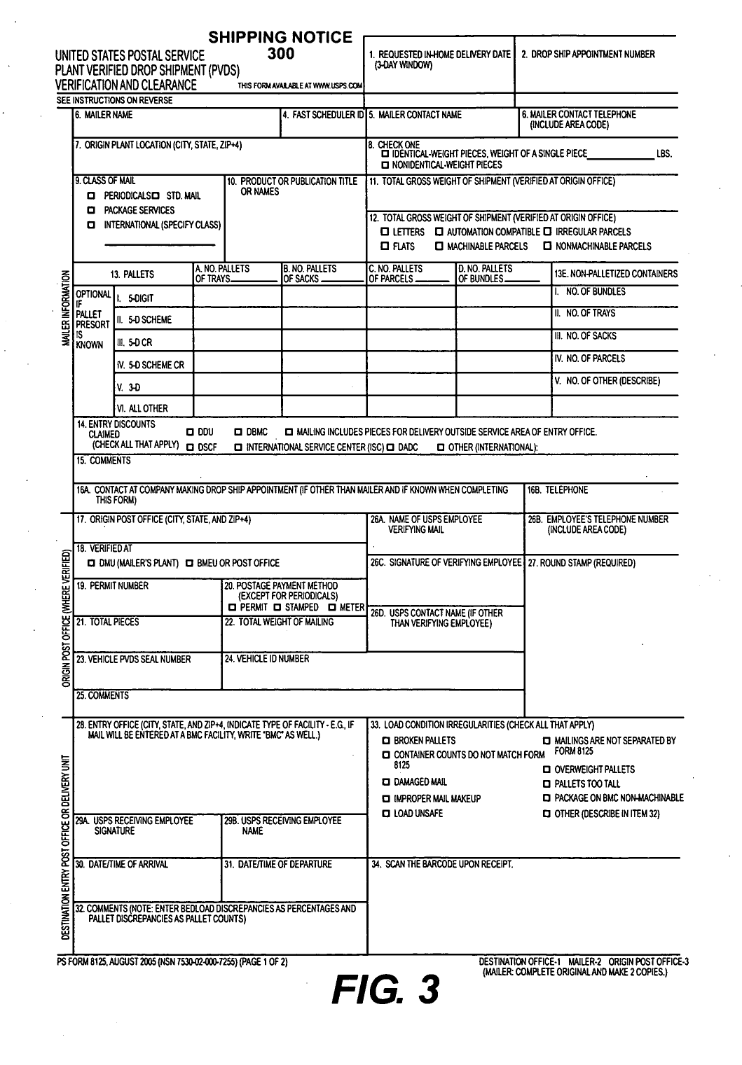

The EMD file contains information about the subscriber's upcoming shipments and mailings. In the EMD file, the subscriber describes several characteristics of its planned mailing (e.g., drop-ship sites, shipment and mailing identification, expected delivery date and time, shipment ID codes, and the like) that will be used on USPS induction forms to track the mailing. When the subscriber drops the mailing with the USPS, the USPS scans the mailing's induction forms, such as a PS Form 8125 shipping notice, to “start the clock” for tracking the mailing. An exemplary EMD file format 200 and an exemplary PS Form 8125 shipping notice 300 are respectively illustrated in FIGS. 2A-H and 2J and FIG. 3, and are described below in more detail.

EMD file 200 is typically a single data text file having comma-delimited fields in a flat file format. Each record in EMD file 200 is made up of a single row of data consisting of multiple data fields (e.g., 55). Data entry is required in mandatory data fields and is optional in optional data fields. If an entry is not provided for an optional data field, the optional data field typically defaults to a null value represented by two commas adjacent to each other. EMD file 200 contains data for one or more delivery item shipments. A shipment may contain one or more mailings, and a mailing can have zero, one, or many PLANET codes. Typically, a subscriber electronically provides the EMD file to the USPS as a pre-shipment notification.

The subscriber's EMD file 200 may also indicate at least one range of PLANET codes that will be used on the mail for piece-level tracking. A single EMD file must be created for each shipment. The subscriber may create EMD file 200 by manually entering the relevant mailing data through a Mail Tracking & Reporting Web site provided by the USPS. Alternatively, the subscriber may create EMD file 200 containing the necessary data in accordance with EMD file specifications, then upload the EMD file to the USPS using a digital protocol (e.g., HTTP, FTP, and the like).

While EMD file 200 functions as a pre-shipment notification for one or more upcoming shipments, PS Form 8125 (FIG. 3) functions as a shipping notice that accompanies a particular shipment as the shipment is delivered through system 10. PS Form 8125 contains information regarding whether the shipment was verified and paid for at its origin (i.e., the plant or facility where the shipment was inducted into system 10). PS Form 8125 shipping notice 300 also provides information for identifying the shipment, such as indications of the type of mail, volume of mail, class of mail, weight of mail, originating mail processing facility, destination mail processing facility, delivery date, shipper's contact information, delivery fee information, and so forth.

PS Form 8125 also may specify a shipment ID associated with the shipment. The shipment ID may be at least partially encoded in a shipment ID barcode that can be printed or otherwise affixed to a predetermined location on PS Form 8125 (or onto another functionally equivalent shipping notice). When the shipment ID barcode is scanned at a mail processing facility, the shipment ID may be matched to data derived from the shipment's associated EMD file, and a notification regarding the shipment may be provided to the subscriber, e.g., either by email and/or file transfer.

PS Form 8125 may include verification and authentication information that can be used at mail processing facilities to verify the integrity of the shipment. To that end, a mail service employee at the origin facility may examine the shipment, before inducting it into the mail flow of system 10, to ensure that the subscriber's PS Form 8125 properly describes the shipment. The employee may stamp, initial, or otherwise authenticate the PS Form 8125. Then, when the shipment and its associated PS Form 8125 are received at a subsequent mail processing facility, such as the shipment's destination facility, another mail service employee may use the authenticated PS Form 8125 to verify the contents and/or delivery-fee payment of the received shipment.

A CONFIRM service subscriber 120a-n may utilize the USPS's CONFIRM service by submitting an EMD file identifying the subscriber's ID number and a PLANET code range for mail tracking. The subscriber also may submit a PS Form 8125 to accompany the mail as it is being tracked by the CONFIRM service. Detailed information regarding the PLANET code and CONFIRM service is disclosed, for example, in the commonly assigned U.S. patent application Ser. No. 10/488,762, filed on Mar. 5, 2004 by Aldstadt, et al. and entitled “Item Tracking and Anticipated Delivery Confirmation System and Method,” which application is incorporated herein by reference in its entirety.

The CONFIRM service allows the subscriber to uniquely identify and track mail by placing a PLANET code on a mailpiece. When the USPS first takes possession of the mailpiece, a USPS representative scans the PLANET code with a mail processing equipment 130a-n prior to inducting the shipment into the mail processing stream. This entry scan serves to “start the clock” on the mailpiece (that is, begin monitoring the mailpiece) and generates entry scan data, which is sent to server 100 for processing and storage. After the mailpiece has been inducted into the USPS's mail flow, mailpiece scan data is created each time the mailpiece is processed on mail processing equipment 130a-n at a mail processing facility. As the mailpiece PLANET code is processed by mail processing equipment 130a-n, one or more data records are created containing the PLANET code, POSTNET code, processing facility, sort operation code, and processing date and time. The data records are distributed electronically to server 100 and given an indication of the mailpiece's status and location in the USPS's mail flow. When the mailpiece is scanned by mail processing equipment 130a-n at a mail process facility that predicts same-day delivery, a “stop-the-clock” scan occurs (that is, end monitoring of the mailpiece). The criteria for a stop-the-clock scan may be that the mailpiece reaches the mail process facility and passes through a sort operation in the mail processing facility before, for example, 10:00 a.m.

As will be appreciated by those skilled in the art, the number and orientation of the components illustrated in FIG. 1 are merely exemplary and do not limit the scope of the invention. Therefore, other arrangements and sets of components are feasible, consistent with the principles of the invention. Further, it is noted that any combination of the components in system 10 may be owned and operated by a delivery service provider, such as the USPS. Moreover, several of the components (such as subscriber computers 120a-n) may be third-party owned and/or operated for the purposes of providing data and/or otherwise facilitating mail entry location by tracking, monitoring, validating, or reconciling data associated with the mail.

In operation, a management system, such as server 100, receives data from various components in the item delivery system 10, such as from subscriber computers 120a-n and mail processing equipment 130a-n. The data sent to the management system may include information derived from PS Form 8125 and EMD files, as well as scan data acquired by the components 120a-n and 130a-n during mail delivery. The received data may be filtered, mapped, and/or otherwise processed prior to analysis by computer 105 or storage in database 110. Such processing may normalize the data and catch exceptions or errors. Subsequent to the processing of data associated with the mail, computer 105 may provide a mail service subscriber the capability to analyze and evaluate mail flow and mail delivery statistics on an aggregate basis. Computer 105 may also provide the subscriber the capability to identify trends, bottlenecks, service standards, and specific problem areas based on actual mail flow using mailing specific PLANET code ranges and date. Furthermore, computer 105 may provide to the subscriber a national snapshot of mail operations to assist the subscriber in analyzing and evaluating mail flow and mail delivery statistics on an aggregate basis. The subscriber may proactively monitor mailings or reactively monitor mailings (e.g., responding to questions or problems arising from a specific mailing).

Although the server 100 may be a management system embodied in a central server (as represented in FIG. 1), the server 100 alternatively may be deployed as any number of distributed servers (not shown). The server 100 functions as a management system comprising software applications and modules for implementing computer 105 and managing database 110 in accordance with the inventive principles described herein. Database 110 may be stored in various types of storage mediums including, for example, magnetic or optical storage mediums. In one embodiment, database 110 may be configured to store information that can be accessed through a conventional database protocol, such as the Structured Query Language (“SQL”). Examples of database 110 include, but are not limited to, an Oracle® relational database management system, a Microsoft® SQL Server, and a Sybase® SQL Server.

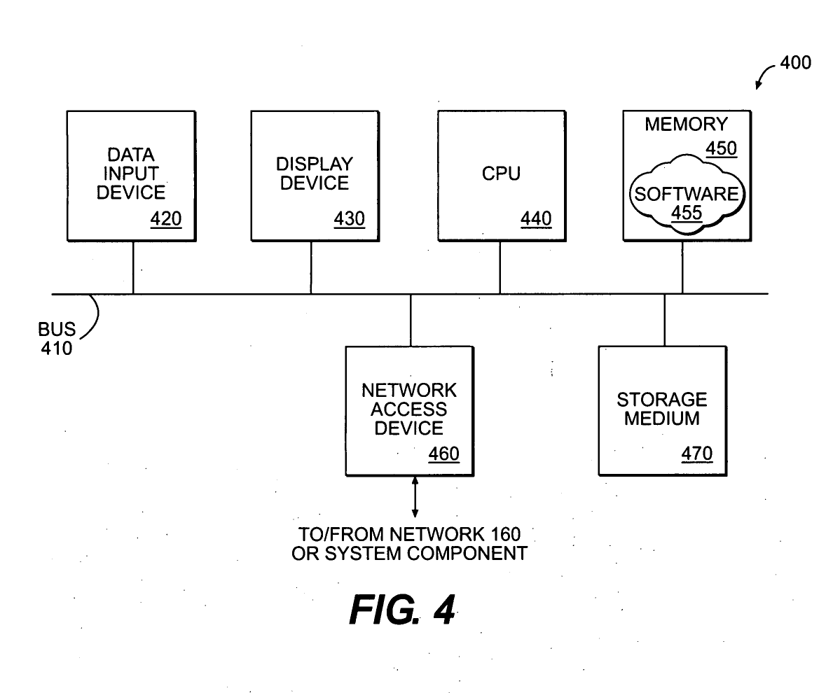

The system components shown in FIG. 1, including server 100, subscriber computers 120a-n, and mail processing equipment 130a-n, may comprise computing devices or platforms. FIG. 4 illustrates an exemplary computing device 400 which may be employed by components in the exemplary item delivery system 10. Computing device 400 may include, inter alia, a central processing unit (CPU) 440, a memory 450, a network access device 460, and a storage medium 470 interconnected by a system bus 410.

CPU 440 may be any appropriate processor or set of processors configured to execute program instructions, such as software 455 resident in the memory 450. Memory 450 may be embodied as a conventional random-access memory or any other type of permanent, semi-permanent, or temporary storage device, including read-only memory and flash memory. Storage medium 470 may comprise one or more disk drives, such as a hard disk drive, an optical drive, or any other type of mass storage device.

Network access device 460 may be a modem, a cable modem, an Ethernet card, a T1 line connector, or any other access device for connecting a respective system component (e.g., server 100, subscriber computers 120, mail processing equipment 130; FIG. 1) to another system component or connecting a respective system component directly to network 160.

Computing device 400 may be connected to one or more input devices 420, such as a keyboard, a mouse, or some other type of means for inputting data to computing device. Computing device 400 may be connected to one or more display devices 430, such as a monitor or any other visual and/or audiovisual output device.

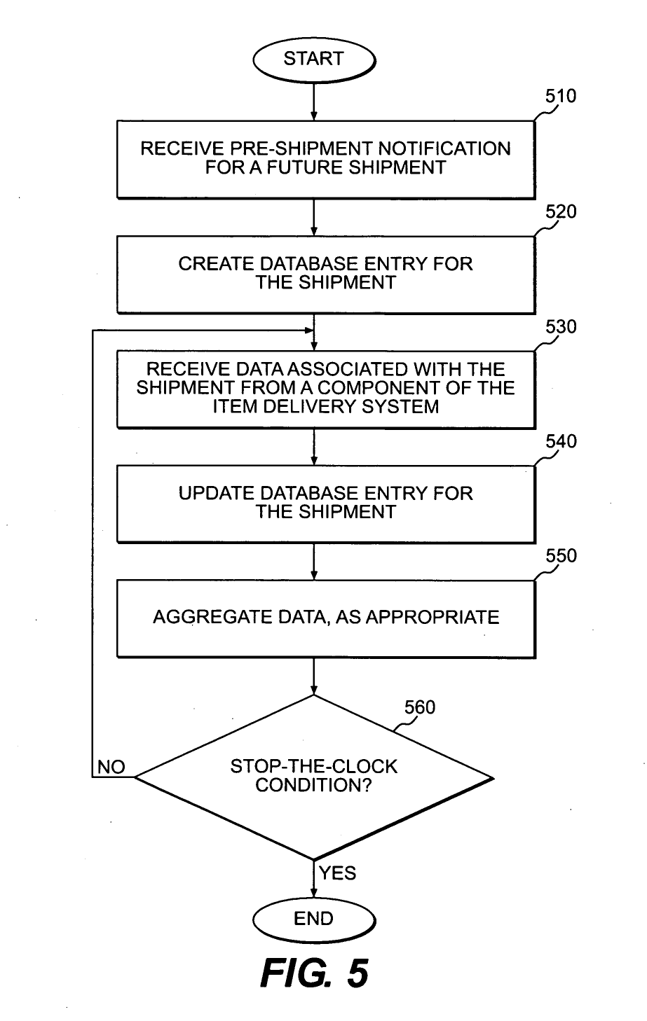

FIG. 5 illustrates a flow diagram of an exemplary process for aggregating mail delivery statistics. At stage 510, server 100 (or other management system) receives a pre-shipment notification, such as an EMD file, for a future shipment of delivery items. Server 100 creates a database entry for the shipment in database 110, at stage 520. Next, at stage 530, server 100 receives data associated with the shipment from a component of the system 10. The component may be, for example, a subscriber computer 120a-n or mail processing equipment 130a-n that forwards the data to server 100 via the network 160, e.g., using a conventional network protocol, such as HTTP or FTP.

At stage 540, server 100 updates the shipment's database entry based on the received data associated with the shipment. Advantageously, server 100 is configured, at stage 550, to aggregate related item delivery data that it receives for a plurality of different shipments according to user commands. Server 100 may store the aggregated data at one or more predetermined locations in database 110. Server 100 also may determine a set of item-delivery statistics based on the aggregated data. As such, server 100 can selectively retrieve aggregated statistics from the database in response to user requests. The aggregated statistics can be used by the requesting user to identify trends, bottlenecks, service standards, traffic analysis, and the like, in system 10. If a stop-the-clock condition exists for the shipment, at stage 560, the process ends. Otherwise, the process returns to stage 530 where server 100 may receive additional data associated with the shipment, e.g., from another component in system 10.

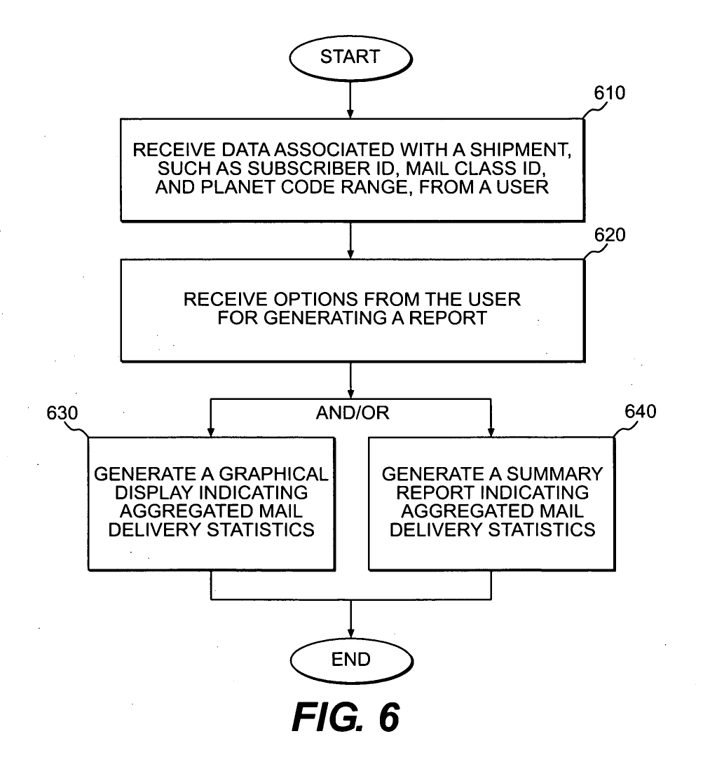

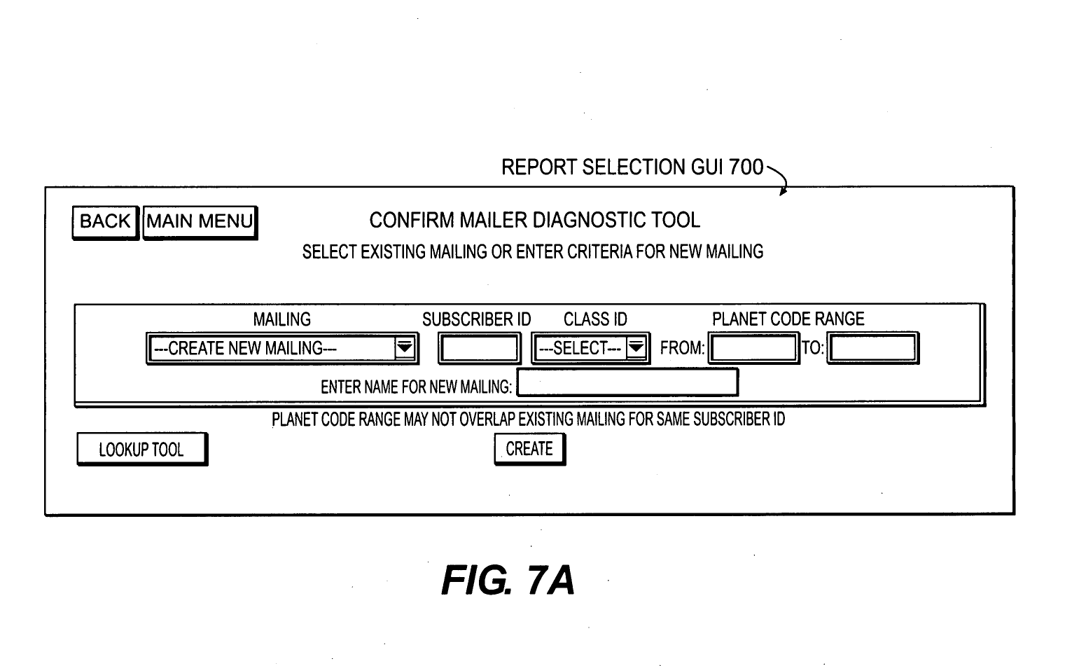

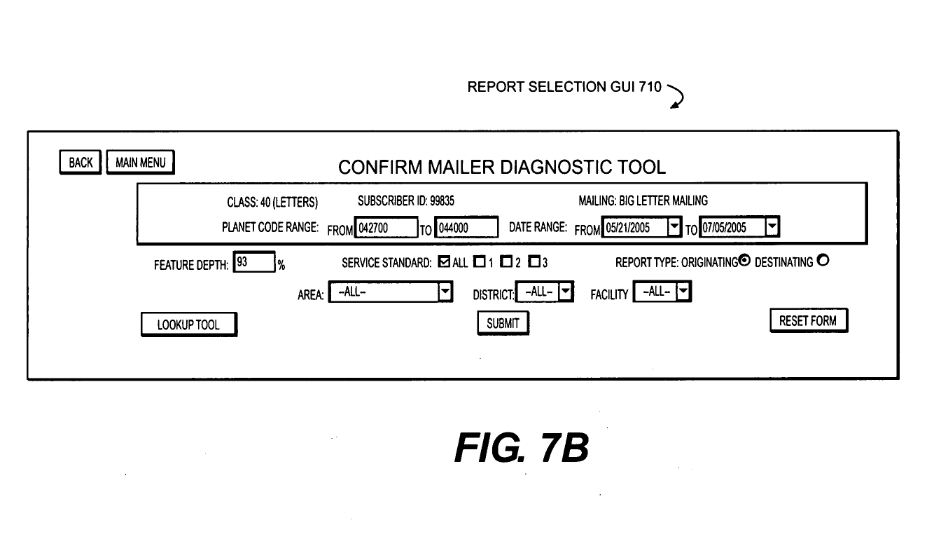

FIG. 6 shows a flow diagram of an exemplary process for providing a mail service subscriber the capability to analyze and evaluate mail flow and delivery statistics on an aggregate basis. Consistent with the illustrative embodiment, the flow diagram will be described with references to system 10, shown in FIG. 1. A user (e.g., a CONFIRM subscriber, a USPS personnel, and the like) submits data associated with a shipment to server 100, the data including, for example, a subscriber ID, a mail class ID, and a PLANET code range, as shown in a graphical user interface 700 depicted in FIG. 7A. The submitted data is received by server 100, at stage 610.

Next, in stage 620, server 100 receives user-selected options for generating a report. The options may specify one or more criteria for determining which aggregation statistics to return to the user. The options may include, for example, a date range, a failure depth (e.g., a threshold value for determining which mail delivery statistics to return to the user, or the manner with which the statistics are displayed to the user, such as displaying statistics above and below the threshold value using different fonts, colors and/or styles), a service standard (e.g., 1-day delivery, 2-day delivery, and the like), a report type (e.g., global, originating and destinating, destinating, originating, and the like), an area (e.g., Northeast, Eastern, Western, Great Lakes, New York Metro, Capital Metro, and the like), a district, a mail processing facility ID, and so forth.

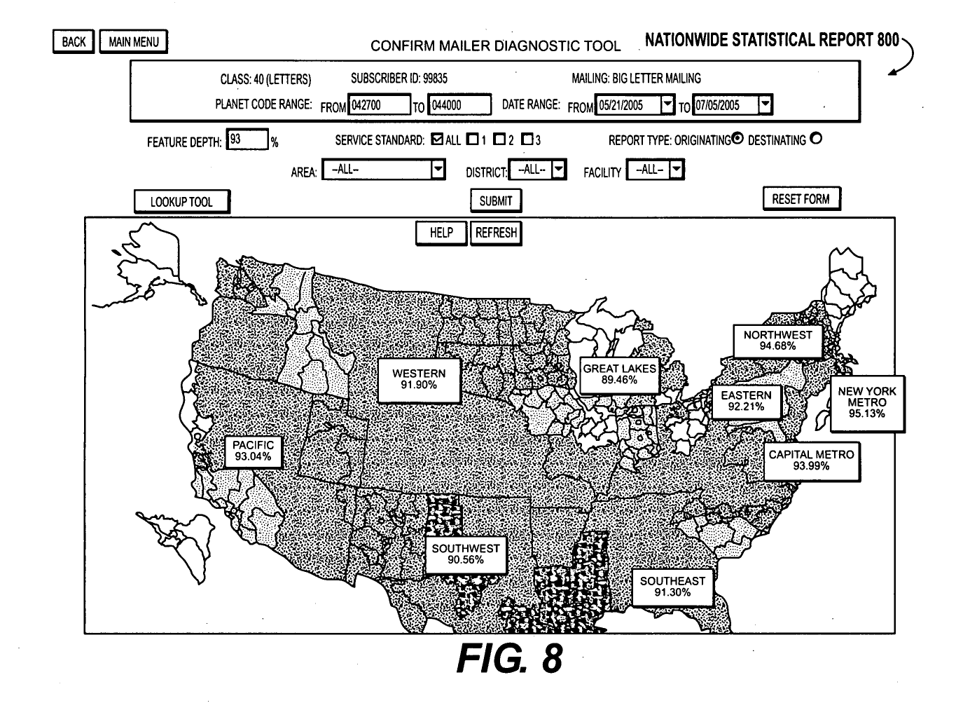

The user-selected options may be received at stage 620 by an exemplary graphical user interface 710 (FIG. 7B) that enables the user to select options for generating a report. Various types of reports may be requested by the user. For example, a “global” report provides the user an overall national performance view by USPS defined delivery areas. An “originating and destinating” report provides the user an aggregated view of mail delivery statistics organized by where the mailpieces entered the USPS's mail flow (i.e., origin) and where the mailings were delivered (i.e., destination). A “destinating” report provides the user an aggregated view of mail delivery statistics arranged by the mailpieces' destination. An “originating” report, an example of which is shown in FIG. 8, provides the user an aggregated view of mail delivery statistics by the mailpieces' origin. The user may filter a report to narrow its search criteria, including, for example, “Regular Pieces,” “On-time,” “Late,” “Unknown,” and/or “Forwarded Pieces,” to view the mailpieces which match the user's filter criteria.

Returning to FIG. 6, stage 630, based on the options selected by the user, server 100 may generate a graphical display indicating aggregated mail delivery statistics. For example, FIG. 8 shows a graphical display 800 which may include a picture or map of the United States, indicating the national performance of mail flow based on the shipments' drop-off locations or their first-scan locations.

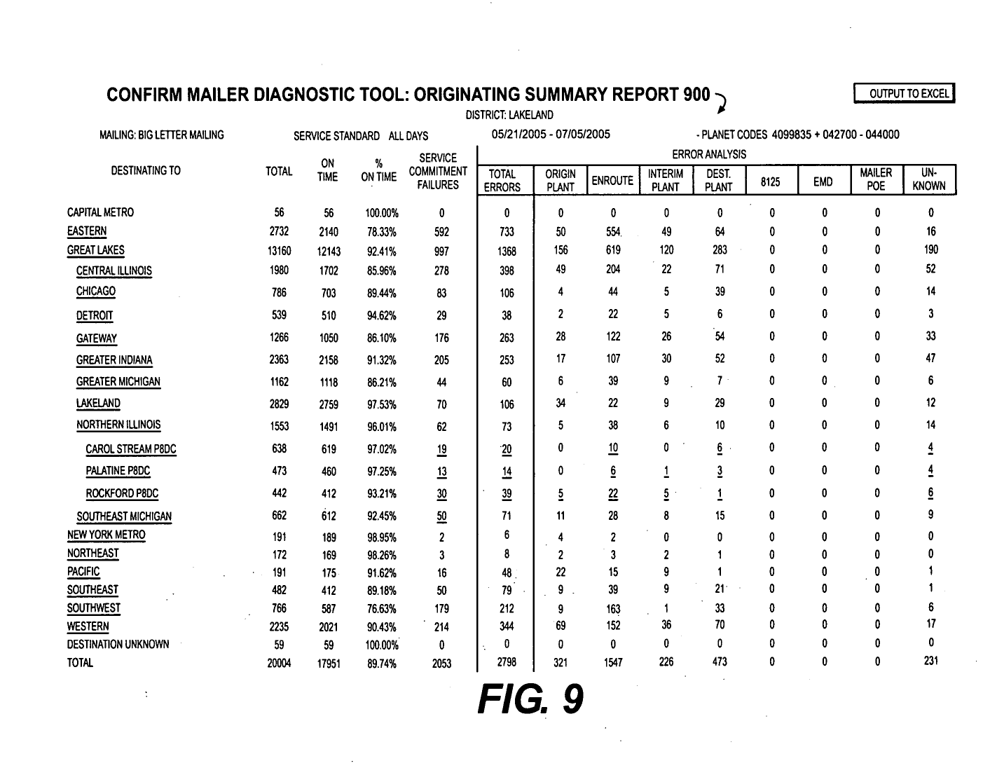

At stage 640, server 100 may generate at least one summary report 900 indicating aggregated mail delivery statistics, e.g., formatted based on piece counts and/or as percentages of piece counts (e.g., delivery failure rates, etc.). An exemplary originating summary report 900 is shown in FIG. 9. In general, the user may generate one or more graphical reports 800 and/or summary reports 900.

The foregoing descriptions of the invention have been presented for purposes of illustration and description. They are not exhaustive and do not limit the invention to the precise form disclosed. Modifications and variations are possible in light of the above teachings or may be acquired from practicing of the invention. For example, the described implementation includes software but the present invention may be implemented as a combination of hardware and software or in hardware alone. Additionally, although aspects of the present invention are described as being stored in memory, one skilled in the art will appreciate that these aspects can also be stored on other types of computer-readable media, such as secondary storage devices, like hard disks, floppy disks, or CD-ROM, a carrier wave from the Internet or other propagation medium, or other forms of random-access or read-only memory.

What is claimed is:

1. A method for aggregating item delivery statistics in an item delivery system, the method comprising:
acquiring data associated with one or more delivery items in the item delivery system;
aggregating at least a portion of the acquired data in accordance with one or more aggregation criteria;
determining a set of item delivery statistics based on the aggregated data;
and
generating a report containing the set of item delivery statistics.

2. The method of claim 1, wherein the one or more delivery items include at least one mailpiece.

3. The method of claim 1, further comprising the step of forwarding the acquired data to a management system in the item delivery system.

4. The method of claim 3, wherein the management system comprises a centralized server.

5. The method of claim 1, wherein the step of acquiring data further comprises acquiring data from a pre-shipment notification file associated with the one or more delivery items.

6. The method of claim 5, wherein the pre-shipment notification file is an electronic data file.

7. The method of claim 1, wherein the step of acquiring data further comprises acquiring data from a shipping notice, the shipping notice accompanying the one or more delivery items as the one or more delivery items are processed in the item delivery system.

8. The method of claim 7, wherein the shipping notice comprises a hard-copy form.

9. The method of claim 7, wherein the shipping notice comprises information for verifying the contents of the one or more delivery items.

10. The method of claim 7, wherein the shipping notice comprises information for verifying the delivery fee paid on the one or more delivery items.

11. The method of claim 7, wherein the shipping notice comprises a shipping identification (ID) code.

12. The method of claim 11, wherein the shipping ID code is at least partially encoded in a barcode.

13. The method of claim 1, wherein the step of acquiring data further comprises scanning one or more optically readable codes associated with the one or more delivery items.

14. The method of claim 13, wherein the one or more optically readable codes include at least one PLANET® code.

15. The method of claim 13, wherein the one or more optically readable codes include at least one POSTNET® code.

16. The method of claim 1, wherein the one or more aggregation criteria are selected by a user in the item delivery system.

17. The method of claim 1, wherein the step of generating a report further comprises generating a graphical display containing the set of item delivery statistics.

18. The method of claim 17, wherein the graphical display depicts a set of nationwide item delivery statistics.

19. The method of claim 1, wherein the step of generating a report further comprises formatting at least some of the item delivery statistics as percentages.

20. An item delivery system, comprising:
a computer network;
at least one processing equipment coupled to the network and configured to process one or more delivery items; and
a management system coupled to the network and configured to communicate with the at least one processing equipment over the network; the management system configured to:
receive data associated with the one or more delivery items from the at least one processing equipment;
aggregate at least a portion of the received data in accordance with one or more aggregation criteria;
determine a set of item delivery statistics based on the aggregated data; and
generate a report containing the set of item delivery statistics.

21. The item delivery system of claim 20, wherein the one or more delivery items include at least one mailpiece.

22. The item delivery system of claim 20, wherein the management system is a centralized server.

23. The item delivery system of claim 20, wherein at least some of the data associated with the one or more delivery items is obtained from a pre-shipment notification file.

24. The item delivery system of claim 20, wherein at least some of the data associated with the one or more delivery items is obtained from a shipping notice, the shipping notice accompanying the one or more delivery items as the one or more delivery items are processed in the item delivery system.

25. The item delivery system of claim 24, wherein the shipping notice comprises a hard-copy form.

26. The item delivery system of claim 24, wherein the shipping notice comprises information for verifying the contents of the one or more delivery items.

27. The item delivery system of claim 24, wherein the shipping notice comprises information for verifying the delivery fee paid on the one or more delivery items.

28. The item delivery system of claim 24, wherein the shipping notice comprises a shipping identification (ID) code.

29. The item delivery system of claim 28, wherein the shipping ID code is at least partially encoded in a barcode.

30. The item delivery system of claim 20, wherein at least some of the data associated with the one or more delivery items is obtained from one or more scanned optically readable codes.

31. The item delivery system of claim 20, wherein the one or more aggregation criteria are selected by a user in the item delivery system.

32. The item delivery system of claim 20, wherein the management system generates a graphical report containing the set of item delivery statistics.

33. An item delivery system, comprising:
means for acquiring data associated with one or more delivery items in the item delivery system;
means for aggregating at least a portion of the acquired data in accordance with one or more aggregation criteria;
means for determining a set of item delivery statistics based on the aggregated data; and
means for generating a report containing the set of item delivery statistics.

34. The item delivery system of claim 33, wherein the one or more delivery items include at least one mailpiece.

35. A computer-implemented method for analyzing and evaluating a flow of mailpieces in association with a shipment of mailpieces, the method comprising:
electronically receiving a data file from a shipper, the data file containing a first set of data associated with the shipment;
scanning, during delivery of the mailpieces, the shipment for a second set of data associated with the shipment;
aggregating the first and second sets of data associated with the shipment in accordance with one or more aggregation criteria; and
reporting the aggregated data.

36. A computer-readable medium configured to store instructions for execution on a processor for the practice of a method of aggregating item delivery statistics in an item delivery system, the method comprising:
acquiring data associated with one or more delivery items in the item delivery system;
aggregating at least a portion of the acquired data in accordance with one or more aggregation criteria;
determining a set of item delivery statistics based on the aggregated data; and
generating a report containing the set of item delivery statistics.
